(19) United States
(12) Patent Application Publication
(10) Pub. No.: US 2006/0208240 A1
(43) Pub. Date: Sep. 21, 2006

(54) Electro-hydraulic hoisting apparatus

(76) Inventors: R. Jason Spittle, Salem, WI (US); Dennis J. Carlton, McHenry, IL (US)

Correspondence Address: Lesavich High-Tech Law Group, P.C., Suite 325, 39 S. LaSalle Street, Chicago, IL, 60603, US

(21) Appl. No.: 11/358,643

(22) Filed: Feb. 21, 2006

Related U.S. Application Data
(60) Provisional application No. 60/662,457, filed on Mar. 15, 2005.

(51) Int. Cl. B60P 1/48

(52) U.S. Cl. 254/8 B

(57) ABSTRACT

An electro-hydraulic lifting apparatus. An electrical controller controls a two-way hydraulic ram via a hydraulic pump. The electrical controller allows a single operator to automatically and precisely (i.e., millimeters, fraction of an inch, etc.) raise and lower a heavy object such as an automobile engine, marine engine, etc., via the electrical-hydraulic lifting apparatus.

### CROSS REFERENCES TO RELATED APPLICATIONS

This application claims priority to U.S. Provisional Patent Application No. 60/662,457, filed Mar. 15, 2005, the contents of which are incorporated by reference.

### FIELD OF THE INVENTION

This invention relates to a hoisting apparatus. More specifically, it relates to an electro-hydraulic lifting apparatus.

### BACKGROUND OF THE INVENTION

There are many different types of hoists to lift and remove objects such as automobile engines, other automobile parts, marine engines, other marine parts, and other heavy objects. However, there are many problems with the hoists known in art.

One problem is that many hoists known in the art include mechanical lifting mechanisms, such as a crank, one or more gears and a cable or winching mechanism. Such mechanical lifting mechanisms typically require a significant amount of strength to lift a heavy object. In addition, such mechanical lifting mechanisms are not very precise and provide a lifting increment tied directly to the gears used for lifting.

Another problem is that other hoists known in the art include hydraulic lifting mechanisms. Such hydraulic lifting mechanisms are more precise than mechanical lifting mechanisms, but still require some physical strength for an operator to lift a heavy object by pumping a handle.

Another problem with hydraulic lifting mechanisms is that most hydraulic rams known in the art can only be controlled to move an object up by adding additional hydraulic pressure by pumping. Such hydraulic rams rely on gravity to move an object down when hydraulic pressure on the rams ire released.

Another problem with hydraulic lift mechanisms is that hydraulic rams are not easily controllable by electrical systems because hydraulic pressure changes dynamically with a load placed on the hydraulic ram.

Another problem with most hoists, including hydraulic hoist known in the art is their operation typically requires two to more people, one to operate the hoisting mechanism, and one to guide the object being lifted.

There have been some attempts to solve some of the problems associated with such hoists. For example, U.S. Pat. No. 6,561,367, entitled “Portable hoist and method,” that issued to Eaton teaches portable hoist has a U-shaped base, a tail assembly with at least a tail leg, an adjustable, telescoping mast secured to the base, a transverse lifting beam secured to the top of the mast and having a roller at each end, and a lifting system attached to a lower portion of the mast and adjacent the base. The lifting system has a winching mechanism and a lifting cable that extends vertically from the winching mechanism to one of the rollers of the lifting beam, across to the second roller and downwardly ending in a free end.

U.S. Pat. No. 6,164,625, entitled “Compactly storable mobile engine hoist,” that issued to Shockley teaches a portable engine hoist which folds into a compact storage position. The base of the hoist is equipped with two support wheels. Two elongated legs extend from the base and are adapted to receive leg extensions. The leg extensions are provided with wheels at one end and the other end can be inserted into a leg. An upright post extends from a base support and carries a pivotally mounted lifting beam at its top end. A mechanical or hydraulic jack operates to raise and lower the lifting beam to raise and lower an engine. Position adjustment and maintenance means for easy assembly of the leg extensions are provided. A cam slot locking means associated with the lifting beam provides stability under the load.

U.S. Pat. No. 5,934,490 teaches a “Combination engine hoist and stand,” that issued to Mora combination engine hoist and stand for lifting and supporting an engine includes a variably oriented “H” shaped multi hinged base with frame extension capability mounted on casters and a combined hoist and stand vertical column located on the base for communicating with and supporting both a hoist and a stand via a collar disposed there between. The hoist includes a boom and a hoist column, the boom pivotally attached to the hoist column and the hoist column attached to the stand column via the collar. The boom is manually adjustable for length via extension elements and the boom height is adjustable by activating a hydraulic jack. A wire rope depends from the outward extending end of the boom and is manually adjustable for length by operating a winch. The boom alone or the entire hoist is removable from the stand as desired. The stand includes a stand column and a shaft that pivotally and slidably communicates with the collar on the stand column and also includes a plate for attachment to an engine. Plate and shaft may likewise be removed from the hoist and stand combination leaving only the hoist supported by the stand column and base. The invention may be used to both remove an engine from an automobile and to support an engine for repair.

U.S. Pat. No. 5,897,101 entitled “Collapsible engine hoist,” that issued to Synder teaches a new collapsible engine hoist for hoisting an engine of a vehicle and being collapsible for convenient and compact storage. The inventive device includes a base tube member with a base extension section having a caster wheel telescopically engaged to each end of the base tube member. Extending from the base tube member are a plurality of spaced apart leg tube members each with a leg extension section having a caster wheel telescopically engaged to the end of each the leg tube member. A support post member having a clevis bracket at one end is pivotally mounted on a support post base extending between the leg tube members to permit pivoting of the support member between an erect position and a collapsed position. Pivotally mounted to the clevis bracket is a lifting beam tube member having extension beam section telescopically engaged to one end of the lifting tube member. The extension beam section includes a flexible member having a hook portion for suspending a load from it. A jack pivotally mounted on the support post member and detachably attached to the lift beam tube member provides a means for pivoting the lifting beam tube member relative to the support post member when in the erect position. At least one support brace pivotally mounted on the base tube member and detachably attached to the support post member provides support to the support post member when positioned in an erect position. A leg support brace extending between the leg tube members provides support to the lifting beam tube member when in the collapsed position.

U.S. Pat. No. 5,375,693 entitled “Multipurpose lifting apparatus,” that issued to Wohlwend teaches lifting apparatus includes a mast that is mounted orthogonally (perpendicularly) to the plane of a base supported by wheels. A beam and tension member are connected pivotally to the mast and further to a carriage assembly support in such a manner that the support and mast maintain a parallel relationship, as do the beam and tension member. A lifting ram is pivotally connected to the mast and to the telescopic beam. During a load lifting operation, the resulting parallelogram configuration of the mast, carriage assembly support, beam, and tension member serve to maintain the tines of the carriage assembly in a plane parallel to the base of the lifting apparatus as the carriage assembly is arcuately raised. The carriage assembly and tension member may be removed in order for the mast and boom to be used as an engine hoist, and the apparatus may be further used as an engine work stand by installing a plate on the engine which is pivotally installable on the mast at the ram attachment point.

U.S. Pat. No. 5,261,640 entitled “Portable engine hoist” that issued to Yuan a portable engine hoist which folds into a compact storage condition. A base of the hoist is equipped with two caster wheels. Two elongated feet extend from the base and carry wheels on their outboard ends. An upright post extends from the base and carries a pivotal lifting beam at its top end. A mechanical jack operates to pivotally raise and lower the lifting beam to raise and lower an engine. An inclined brace extends from the post and carries a cross arm which may be bolted to the feet to provide a rigid brace structure. When the cross arm is unbolted from the feet, it may be pivoted until it is clear of the feet. The feet can then be pivoted upwardly and latched for storage of the hoist.

U.S. Pat. No. 5,188,247, entitled “Lifting apparatus,” that issued to Jastrow teaches a lifting apparatus that permits an object to be precisely lifted in a highly safe manner along a number of selected paths. The object to be lifted can be vertically raised along selected transversely spaced paths by vertically raising the lifting arms of the apparatus and can alternatively, or simultaneously, be pivotably lifted by imparting a pivotal, upward movement of the lifting arms relative to the base assembly. The cable or chain which actually lifts the engine is connected to a carriage that reciprocates along tracks which transversely span the lifting arms. In this way the lifting path can be varied either to the right or left.

U.S. Pat. No. 5,052,566 entitled “Engine hoist and support apparatus,” teaches an apparatus including a central vertical support post, including a plurality of support legs orthogonally mounted to a lower end of the support post. The support post pivotally mounts a support boom at an upper end thereof, with a rear terminal end of the support boom including a plurality of chain members, with lower ends of the chain members mounted to a lower chain support beam that is orthogonally mounted to a telescoping portion of a jack member. The apparatus includes an engine support plate mounted upon a forward face of the support post. A modification of the invention includes the support post oriented at an obtuse angle relative to the support legs pivotally mounting the support boom at a rear terminal end of the support boom, with the jack member positioned medially of the support boom between the support boom and the engine support plate.

U.S. Pat. No. 4,899,985, entitled “Low-profile hydraulic lift,” that issued to Goods teaches a castered, low-profile, hydraulic lift assembly including a pivoting lift arm supporting a plurality of detachable transition arms and lift heads. Slip couplers, including linch pins and set screws mating with the arms and lift heads, adjustably position the proper head in overlying or underlying relation to the workpiece. The lift heads, which include workpiece securing hooks, support yokes, chains and support harnesses, slip mount to a slotted end of the outermost arm.

U.S. Pat. No. 4,770,304, entitled “Mobile engine hoist and rebuild stand assembly” that issued to Woods an engine hoist and rebuild stand assembly is provided including an upright standard and an inclined boom removably supported from the upper end of the standard. The boom includes a lengthwise extendable load lifting end provided with a guide pulley over which an elongated flexible tension member may be passed and the end of the tension member which passes over the guide pulley is operatively connected to winding and unwinding structure carried by the non-extendable end of the boom. Further, the standard includes a horizontal transverse base outwardly from which a pair of generally parallel leg assemblies project in generally the same direction from which the extendable end of the boom projects from the standard and a mid-height portion of the standard includes a mount supported therefrom for selectively angular displacement about a horizontal axis generally paralleling the leg assemblies and from which mount the bell housing end of an engine may be securely mounted.

U.S. Pat. No. 4,479,632 entitled “Dolly for an automotive engine” that issued to Mcintire et al. teaches a dolly for adjustably supporting an automobile engine or the like includes a frame extending substantially horizontally and having forward and rearward ends, caster wheels mounted to the forward and the rearward end of the frame, a post mounted to the rearward end of the frame and extending upwardly therefrom, a first boom member having a rearward end pivotally mounted to the post and extending toward the forward frame end, a second boom member having a rearward end pivotally attached to the first boom member forward end and extending toward the forward frame end and terminating at an end adapted to receive a workpiece, a cylinder actuator for pivoting the first boom member about the post, and a second cylinder actuator for pivoting the second boom member about the first boom member forward end. An engine attached to the second boom member is suspended above the forward end of the frame which has a sufficiently low profile to pass beneath the front of an automobile, enabling the engine to be positioned within the vehicle engine compartment beneath the hood, and the cylinder actuators enable the engine to be positioned to facilitate mounting the engine within the vehicle.

U.S. Pat. No. 4,133,514, entitled “Engine hoist attachment for automobiles,” that issued to Anderson teaches an engine hoist with a hydraulically powered lifting boom is attached to and used in combination with an automobile hoist.

However, none of these solutions solve all of the problems associated with hoisting apparatus. Thus, it is desirable to provide a hoisting apparatus that provides a precise lifting mechanism, does not require a lot of physical strength for the operator and can be used by one operator.

### SUMMARY OF THE INVENTION

In accordance with preferred embodiments of the present invention, some of the problems associated with hoists are overcome. An electro-hydraulic lifting apparatus is presented.

An electro-hydraulic lifting apparatus includes an electrical controller and a hydraulic pump with plural electro-static that allows a single operator to automatically and precisely (i.e., millimeters, fraction of an inch, etc.) raise and lower a heavy object such as an automobile engine, marine engine, etc., via the electrical-hydraulic apparatus.

The foregoing and other features and advantages of preferred embodiments of the present invention will be more readily apparent from the following detailed description. The detailed description proceeds with references to the accompanying drawings.

### BRIEF DESCRIPTION OF THE DRAWINGS

Preferred embodiments of the present invention are described with reference to the following drawings, wherein:

FIG. 1 is a block diagram illustrating an exemplary electro-hydraulic lifting apparatus;

FIG. 2 is a block diagram illustrating a picture of the exemplary electro-hydraulic lifting apparatus.

FIG. 3 is a block diagram illustrating a picture of a close-up view of a portion electro-hydraulic lifting apparatus;

FIG. 4 is a block diagram illustrating a picture of the hydraulic pump;

FIG. 5 is a block diagram illustrating a picture of the hydraulic pump and the hydraulic reservoir;

FIG. 6 is a block diagram illustrating a picture of the electrical controller for one embodiment of the invention;

FIG. 7 is a block diagram illustrating a picture of another electrical controller, electric motor and hydraulic reservoir for another embodiment of the invention;

FIG. 8 is a block diagram illustrating a picture of another portion of the portion electro-hydraulic lifting apparatus;

FIG. 9 is a block diagram illustrating a picture of an exemplary power source;

FIG. 10 is block diagram illustrating another view of the hydraulic pump hydraulic reservoir and portable power source for an embodiment of the invention;

FIG. 11 is a block diagram illustrating another view of various components of the electro-hydraulic hoisting apparatus; and

FIG. 12 is a block diagram illustrating another exemplary electro-hydraulic lifting apparatus.

### DETAILED DESCRIPTION OF THE INVENTION

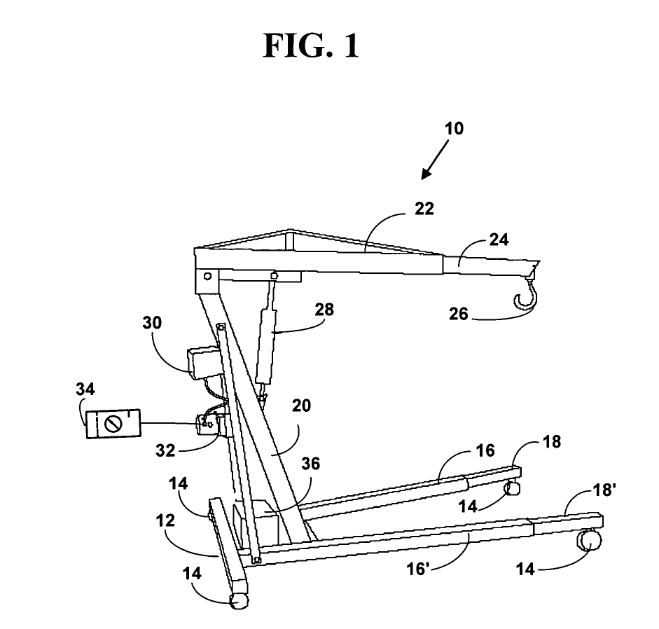

FIG. 1 is a block diagram illustrating an exemplary electro-hydraulic lifting apparatus 10. The electro-hydraulic lifting apparatus 10 includes a horizontal base 12. The horizontal base 12 is equipped with two or more support wheels 14, four of which are illustrated. However, the present invention is not limited to four support wheels, and more or fewer support wheels can also be used. The support wheels 14 allow the apparatus 10 to be easily moved. In another embodiment, the apparatus 10 does not include the two or more support wheels 14 and is stationary.

In another embodiment, the apparatus 10 includes only two support wheels attached to the back of the base 12. In such an embodiment, the apparatus is tipped back onto the two support wheels and then can be moved from placed to place. In one embodiment, the two support wheels are larger wheels with air-filled tires.

Two elongated legs 16, 16′ extend perpendicular from the base 12 and are adapted to receive leg extensions 18. In one embodiment, the leg extensions 18 are manually controllable and have support wheels 14 at one end and another end that is tapered that is inserted into a leg 16, 16′. In one embodiment, the two elongated legs 16, 16′ are controllable (e.g., hydraulically, electrically, etc.) by the electrical controller 34 described below.

A vertical-oriented support component 20 extends from the base 12 and includes a pivotally mounted lifting beam 22 at its top end. The vertical-oriented support component 20 includes a vertical-orientation. In one embodiment, the vertical-oriented support component 20 is connected to the horizontal base 12 at a ninety degree angle. In another embodiment, the vertical-oriented support component 20 is connected to the horizontal base 12 at an angle between fifteen and ninety degrees.

The pivotally mounted lifting beam 22 includes a horizontal telescoping boom 24 and a hoisting apparatus 26.

The horizontal telescoping boom 24 height is horizontally hydraulically (or electrically or manually) adjustable for length via one or more extension elements. A height for the telescoping boom 24 is hydraulically adjustable via a hydraulic ram 28.

The pivotally mounted lifting beam 22 includes plural different hoisting apparatus 26 specifically sized and shaped for lifting pre-determined objects. For example, the plural hoisting apparatus 26 includes a hook for hooking a chain attached to a motor, a bracket for attaching to a transmission, etc.

The hydraulic ram 28 includes a two-way controllable hydraulic ram. The two-way hydraulic ram is controllable in an up direction for lifting and a down direction for lowering. Such a hydraulic ram does not rely on gravity to lower an object that has been lifted and is precisely controllable in both the up and down direction.

A hydraulic reservoir 30 provides hydraulic fluid for hydraulic pressure for the hydraulic ram 28. In another embodiment, the hydraulic ram 28 may use transmission fluid or other fluids suitable to maintain pressure in the two-way ram 28. Such fluids are stored in the hydraulic reservoir 30.

An electrical controller 34 precisely controls the hydraulic pump 32. The electrical controller 34 allows the telescoping boom 24 and the hoisting apparatus 26 via the two-way hydraulic ram 28 and hydraulic reservoir 30 to be moved a very small and very precise distance in pre-defined increments (e.g., fractions of an inch (e.g., 1/16″, millimeters, centimeters, etc.)) up and down at any time. This allows a single operator to precisely raise and lower a heavy object such as an automobile engine, marine engine, etc. In one exemplary embodiment, the pre-defined increments include a precision of at least 1/16″ increments or smaller increments. However, the present invention is not limited to such an embodiment, and other precision increments and other measurement system (e.g., metric, etc.) can also be used to practice the invention.

The electrical controller 34 sends electrical signals to plural electro-static valves connected to hydraulic pump 32 which in turn causes a change in pressure in the hydraulic ram 28 to precisely raise and lower the telescoping boom 24. The electrical controller 34 can also be used to send electrical signals to precisely extend and retract the telescoping boom 24. The electrical controller 34 allows both the hydraulic pump 32 and the two-way hydraulic ram 28 both to be used to precisely place a heavy object in a desired position (e.g., to insert bolts or other connectors, etc.).

The electrical controller 34 controls plural electro-static valves connected to the hydraulic pump 32 to regulate pressure in the hydraulic ram 28 in a dynamic automatic feedback manner. In one embodiment, two electro-static valves are used. However, the present invention is not limited to this embodiment and more or fewer electro-static or other types of valves can be used to practice the invention.

In one embodiment, it has been determined experimentally that the plural electro-static valves automatically and continuously measure and adjust hydraulic pressure on the two-way hydraulic ram and adjust the hydraulic pressure with a flow of no more than 0.75 gallons-per-minute. However, the present invention is not limited to this embodiment and more other hydraulic flow pressures and other measurement systems can be used to practice the invention.

For example, when a large load is added to the telescoping boom 24 and the boom 24 is moved up and down, the plural electro-static valves connected to the hydraulic pump 32 automatically, constantly and dynamically request changes in pressure in the two-way hydraulic ram 28 via the hydraulic pump 32. If the hydraulic pressure is not dynamically adjusted under load conditions, the apparatus 10 tends to “bounce” up and down or otherwise move when a load is moved up and down and/or the apparatus 10 is moved horizontally across a surface when a load is applied.

In another embodiment, the electrical controller 34 includes an up button and a down button. In another embodiment, the electrical controller includes one or more other buttons, knobs or control levers (e.g., round, sliding, etc.) that allows a user to automatically or manually adjust pressure in the hydraulic pump 32. The manual adjustment means allow a user to manual control the electro-static valves connected to the hydraulic pump 32. In such an embodiment, no automatic constant or dynamic control is used.

In another embodiment, the electrical controller 34 includes two modes: (1) an automatic dynamic control mode; and (2) a manual control mode. In such an embodiment, the electrical controller 34 includes an additional switch to switch between the two modes.

In one embodiment, the electrical controller 34 is wired controller directly connected to the hydraulic pump 32. In another embodiment, the electrical controller 34 a wireless controller. In such an embodiment, the hydraulic pump 32 further includes a wireless transceiver that communicates with the wireless controller 34.

Preferred embodiments of the present invention include wireless interfaces that are compliant with all or part of standards proposed by the Institute of Electrical and Electronic Engineers (IEEE), International Telecommunications Union-Telecommunication Standardization Sector (ITU), European Telecommunications Standards Institute (ETSI), Internet Engineering Task Force (IETF), U.S. National Institute of Security Technology (NIST), American National Standard Institute (ANSI), Wireless Application Protocol (WAP) Forum, Bluetooth Forum, or the ADSL Forum. However, network devices based on other standards could also be used. IEEE standards can be found on the World Wide Web at the Universal Resource Locator (URL) “www.ieee.org.” The ITU, (formerly known as the CCITT) standards can be found at the URL “www.itu.ch.” ETSI standards can be found at the URL “www.etsi.org.” IETF standards can be found at the URL “www.ietf.org.” The NIST standards can be found at the URL “www.nist.gov.” The ANSI standards can be found at the URL “www.ansi.org.” Bluetooth Forum documents can be found at the URL “www.bluetooth.com.”

In one embodiment of the present invention, the wireless transceiver includes but are not limited to, wireless interface for an IEEE 802.11a, 802.11b, 802.11g, 802.11n, 802.15.4 (ZigBee), 802.16a, 802.16g, “Wireless Fidelity” (Wi-Fi), “Worldwide Interoperability for Microwave Access” (WiMAX), ETSI High Performance Radio Metropolitan Area Network (HIPERMAN) “RF Home,” Bluetooth, infrared, or other types of wireless interfaces. However, the present invention is not limited to such wireless interface and other types of wireless interfaces can also be used.

As is known in the art, an 802.11b is a short-range wireless network standard. The IEEE 802.11b standard defines wireless interfaces that provide up to 11 Mbps wireless data transmission to and from wireless devices over short ranges. 802.11a is an extension of the 802.11b and can deliver speeds up to 54M bps. 802.11g deliver speeds on par with 802.11a. However, other 802.11xx interfaces can also be used and the present invention is not limited to the 802.11 protocols defined. The IEEE 802.11a, 802.11b and 802.11g standards are incorporated herein by reference.

As is known in the art, Wi-Fi is a type of 802.11xx interface, whether 802.11b, 802.11a, dual-band, etc. Wi-Fi devices include an RF interfaces such as 2.4 GHz for 802.11b or 802.11g and 5 GHz for 802.11a. More information on Wi-Fi can be found at the URL “www.weca.net.”

As is known in the art, 802.15.4 (Zigbee) is low data rate network standard used for mesh network devices such as sensors, interactive toys, smart badges, remote controls, and home automation. The 802.15.4 standard provides data rates of 250 kbps, 40 kbps, and 20 kbps., two addressing modes; 16-bit short and 64-bit IEEE addressing, support for critical latency devices, such as joysticks, Carrier Sense Multiple Access/Collision Avoidance, (CSMA-CA) channel access, automatic network establishment by a coordinator, fully handshaked protocol for transfer reliability, power management to ensure low power consumption for multi-month to multi-year battery usage and up to 16 channels in the 2.4 GHz ISM band (Worldwide), 10 channels in the 915 MHz (US) and one channel in the 868 MHz band (Europe). The IEEE 802.15.4-2003 standard is incorporated herein by reference. More information on 802.15.4 and ZigBee can be found at the URL “www.ieee802.org” and “www.zigbee.org” respectively.

As is known in the art, WiMAX is an industry trade organization formed by leading communications component and equipment companies to promote and certify compatibility and interoperability of broadband wireless access equipment that conforms to the IEEE 802.16XX and ETSI HIPERMAN. HIPERMAN is the European standard for metropolitan area networks (MAN).

The IEEE The 802.16a and 802.16g standards are wireless MAN technology standard that provides a wireless alternative to cable, DSL and T1/E1 for last mile broadband access. It is also used as complimentary technology to connect IEEE 802.11XX hot spots to the Internet.

The IEEE 802.16a standard for 2-11 GHz is a wireless MAN technology that provides broadband wireless connectivity to fixed, portable and nomadic devices. It provides up to 50-kilometers of service area range, allows users to get broadband connectivity without needing direct line of sight with the base station, and provides total data rates of up to 280 Mbps per base station, which is enough bandwidth to simultaneously support hundreds of businesses with T1/E1-type connectivity and thousands of homes with DSL-type connectivity with a single base station. The IEEE 802.16g provides up to 100 Mbps.

The IEEE 802.16e standard is an extension to the approved IEEE 802.16/16a/16g standard. The purpose of 802.16e is to add limited mobility to the current standard which is designed for fixed operation.

The ESTI HIPERMAN standard is an interoperable broadband fixed wireless access standard for systems operating at radio frequencies between 2 GHz and 11 GHz.

The IEEE 802.16a, 802.16e and 802.16g standards are incorporated herein by reference. More information on WiMAX can be found at the URL “www.wimaxforum.org.” WiMAX can be used to provide a WLP.

The ETSI HIPERMAN standards TR 101 031, TR 101 475, TR 101 493-1 through TR 101 493-3, TR 101 761-1 through TR 101 761-4, TR 101 762, TR 101 763-1 through TR 101 763-3 and TR 101 957 are incorporated herein by reference. More information on ETSI standards can be found at the URL “www.etsi.org.” ETSI HIPERMAN can be used to provide a WLP.

As is known in the art, Bluetooth is a short-range radio frequency technology aimed at simplifying communications among network devices and between network devices. Bluetooth wireless technology supports both short-range point-to-point and point-to-multipoint connections. The Bluetooth Specification, GL 11r02, March 2005, prepared by the Bluetooth SIG, Inc. is incorporated herein by reference.

A portable power source 36 provides power for the electrical controller 34 and the electrical motor 32. In one embodiment, the portable power source 36 includes a six-volt, twelve-volt or twenty-four volt direct current (DC) automobile, marine or other battery.

In another embodiment of the invention, the portable power source 36 is a large capacitor that is charged with an external device such as an electrical-mechanical pump. In another embodiment, the portable power source 36 is an ambient radio wave receiver that picks up radio waves from radio stations with an integral antenna to collect and store power.

A battery or other portable power source is preferred to allow the apparatus 10 to be used anywhere and moved from place to place with being tied to a power outlet. In another embodiment, the power source 36 includes an alternating current (AC) power source for 110 volt, 220 volt or other voltage electrical power.

In another embodiment, the electro-hydraulic lifting apparatus 10 further includes a wire rope or cable (not visible in FIG. 1) connected to the hoisting apparatus 26 at one end and a cable collector (not visible in FIG. 1) at another end and extends through the upright component 20 through telescoping boom 24 to the hoisting apparatus 26 and is adjustable for length.

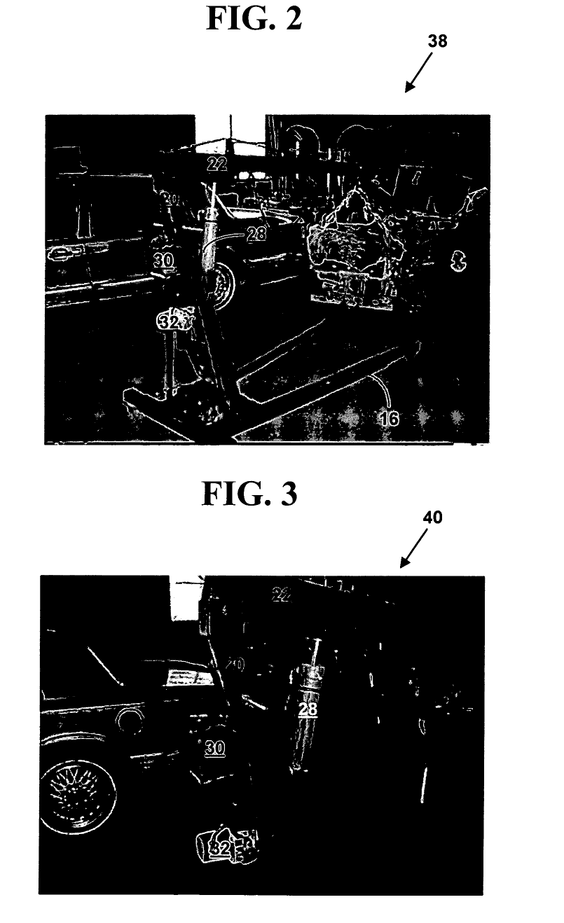

FIG. 2 is a block diagram illustrating a picture 38 of the exemplary electro-hydraulic lifting apparatus 10.

FIG. 3 is a block diagram illustrating a picture 40 of a close-up view of the portion electro-hydraulic lifting apparatus 10.

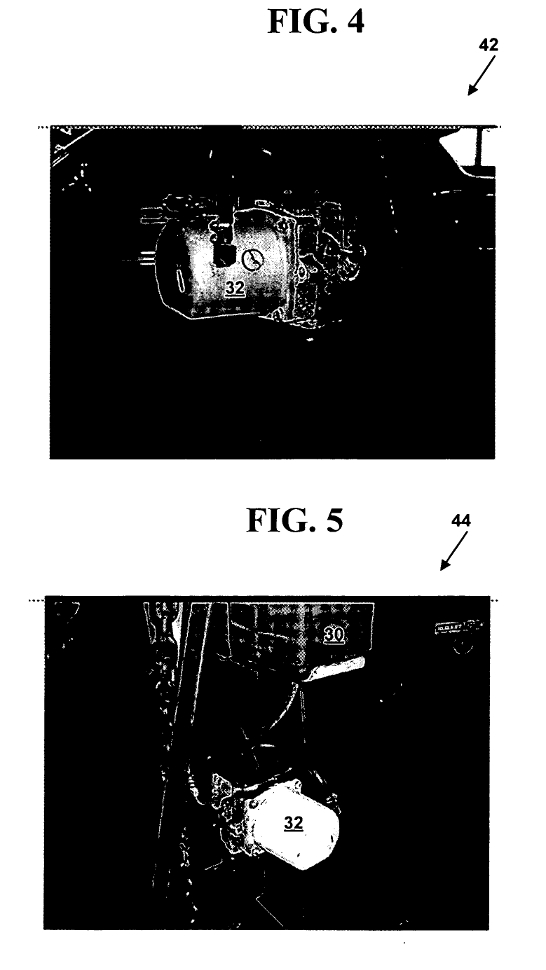

FIG. 4 is a block diagram illustrating a picture 42 of the hydraulic pump 32.

FIG. 5 is a block diagram illustrating a picture 44 of the hydraulic pump 32 and the hydraulic reservoir 30.

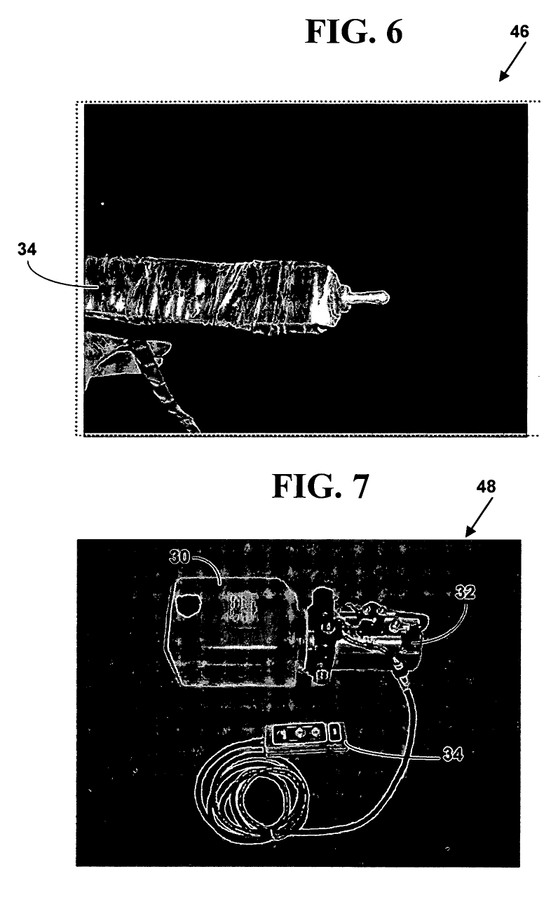

FIG. 6 is a block diagram illustrating a picture 46 of the electrical controller 34 for one embodiment of the invention.

FIG. 7 is a block diagram illustrating a picture 48 of another electrical controller 34, hydraulic pump 32 and hydraulic reservoir 30 for an embodiment of the invention.

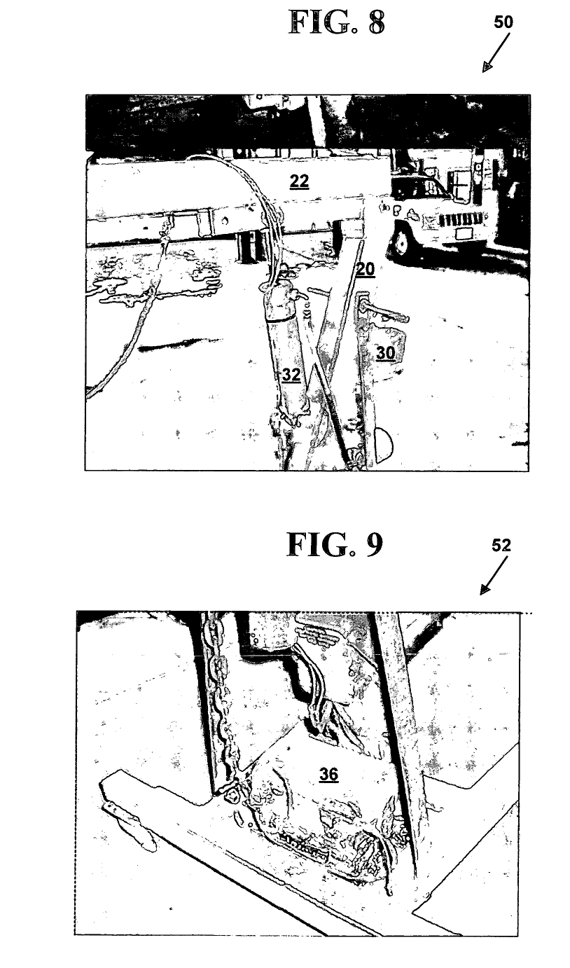

FIG. 8 is a block diagram illustrating a picture 50 of another portion of the portion electro-hydraulic lifting apparatus 10 illustrating a side view the two-way hydraulic ram 32.

FIG. 9 is a block diagram illustrating a picture 52 of an exemplary power source 36.

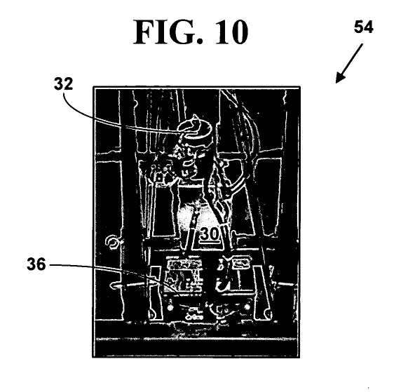

FIG. 10 is block diagram illustrating another view 54 of the hydraulic pump 32 hydraulic reservoir 30 and portable power source 36 for an embodiment of the invention.

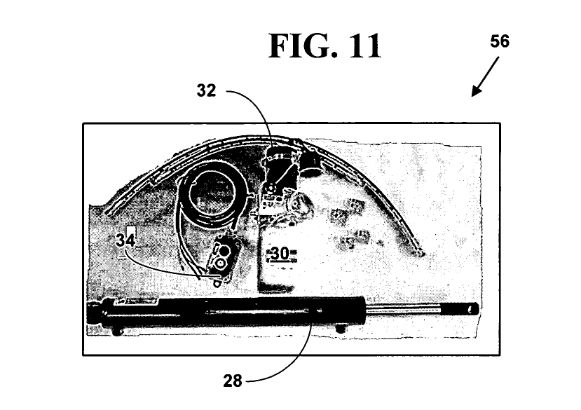

FIG. 11 is a block diagram 56 illustrating another view of various components of the electro-hydraulic hoisting apparatus 10.

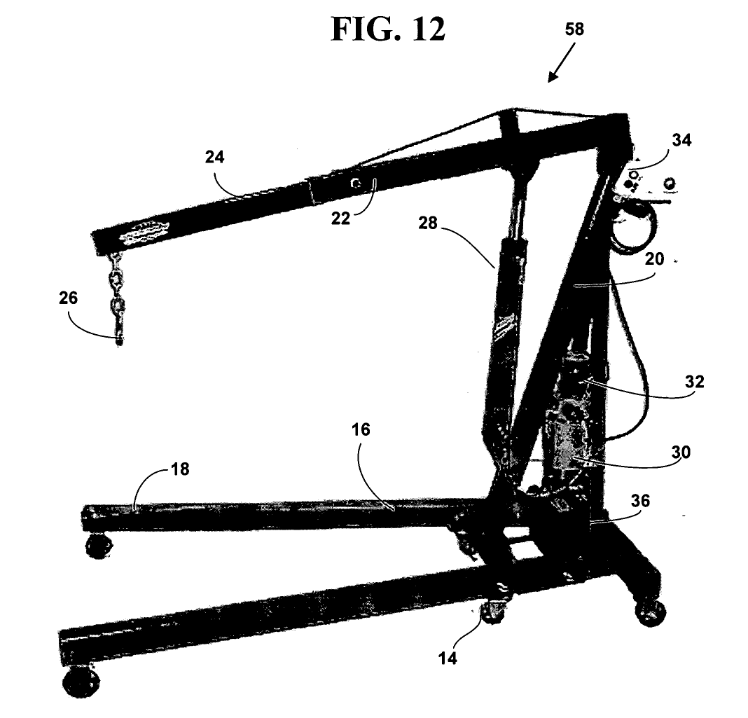

FIG. 12 is a block diagram 58 illustrating another exemplary electro-hydraulic lifting apparatus.

Embodiments of the invention can be used to lift heavy objects such as engines, transmissions, etc. The invention can also be used in the plumbing industry to lift pipes and valves, in a hospital or doctors office to lift overweight or other-wise disabled patients. In another embodiment, the invention can be used to lift animals (e.g., cow, horse, buffalo, bear, deer, etc.) on a farm, ranch, zoo, animal preserve or in a veterinary clinic or veterinary office. In another embodiment, the apparatus 10 is modified and is used to raise or lift camping trailers, boat trailers semi-truck trailers, etc. and is included as an integral portion thereof.

It should be understood that the specific components and apparatus described herein are not related or limited to any particular type apparatus unless indicated otherwise. Various types of general purpose or specialized apparatus may be used with or perform operations in accordance with the teachings described herein.

In view of the wide variety of embodiments to which the principles of the present invention can be applied, it should be understood that the illustrated embodiments are exemplary only, and should not be taken as limiting the scope of the present invention. For example, the apparatus described may include more or fewer elements.

The claims should not be read as limited to the described order or elements unless stated to that effect. In addition, use of the term “means” in any claim is intended to invoke 35 U.S.C. §112, paragraph 6, and any claim without the word “means” is not so intended.

Therefore, all embodiments that come within the scope and spirit of the following claims and equivalents thereto are claimed as the invention.

We claim:

1. An electro-hydraulic lifting apparatus, comprising in combination:
a horizontal base;
two or more horizontally-oriented elongated legs extending perpendicularly from and attached to the base, wherein the two or more horizontally-elongated legs are adapted for accepting leg extensions to provide additional stability for the horizontal base;
a vertical-oriented support component connected to the horizontal base for accepting a telescopic boom;
a pivotally mounted lifting beam including a horizontal telescoping boom and a hoisting apparatus connected to the vertical-oriented support component, wherein the horizontal telescopic boom connected to the vertical support for precisely raising and lowering an object;
a two-way hydraulic ram connected between the vertical-oriented support and the horizontal telescopic boom for precisely raising and lowering an object via the horizontal telescopic boom in an up or down direction, wherein the two-way hydraulic ram is precisely raised and lowered with hydraulic pressure from a reservoir;
a reservoir connected to the two-way hydraulic ram to supply hydraulic fluid to provide hydraulic pressure to the two-way hydraulic ram;
a hydraulic pump connected to the hydraulic ram including a plurality of electro-static valves for automatically and dynamically controlling the two-way hydraulic ram by automatically adding or removing hydraulic pressure to the two-way hydraulic ram when a load is applied to the horizontal telescopic boom and the horizontal telescopic boom is moved in an up or down direction;
an electrical controller connected to the hydraulic pump for controlling the hydraulic pump, thereby automatically, dynamically and precisely controlling the two-way hydraulic ram; and
a portable power source for providing power to the electrical controller and the hydraulic pump.

2. The electro-hydraulic lifting apparatus of claim 1 wherein horizontal telescopic boom is extendable horizontally hydraulically or electrically.

3. The electro-hydraulic lifting apparatus of claim 1 wherein a two-way hydraulic ram does not rely on gravity to lower the horizontal telescope boom.

4. The electro-hydraulic lifting apparatus of claim 1 wherein the reservoir includes transmission fluid instead of hydraulic fluid.

5. The electro-hydraulic lifting apparatus of claim 1 wherein two-way hydraulic ram is precisely raised and lowered with hydraulic pressure with a precision of least one-sixteenth-inch increments.

6. The electro-hydraulic lifting apparatus of claim 1 wherein the electrical controller includes an up button and a down button.

7. The electro-hydraulic lifting apparatus of claim 1 wherein the electrical controller includes one or more other buttons, knobs, round control lever or sliding control lever.

8. The electro-hydraulic lifting apparatus of claim 1 wherein the electrical controller is a wireless electrical controller.

9. The electro-hydraulic lifting apparatus of claim 1 wherein the wireless electrical controller includes a IEEE 802.11a, 802.11b, 802.11g, 802.11n, 802.15.4 (ZigBee), 802.16a, 802.16g, Wireless Fidelity (Wi-Fi), Worldwide Interoperability for Microwave Access (WiMAX), ETSI High Performance Radio Metropolitan Area Network (HIPERMAN) RF Home, Bluetooth, infrared wireless interface.

10. The electro-hydraulic lifting apparatus of claim 1, wherein the portable power source includes a direct current battery.

11. The electro-hydraulic lifting apparatus of claim 10, wherein the direct current battery includes a six-volt, twelve-volt or twenty-four volt direct current battery.

12. The electro-hydraulic lifting apparatus of claim 1 wherein the plurality of electro-static valves continuously measure and adjust hydraulic pressure on the two-way hydraulic ram and adjust the hydraulic pressure with a flow of no more than 0.75 gallons-per-minute.

13. The electro-hydraulic lifting apparatus of claim 1 wherein the a pivotally mounted lifting beam includes a plurality of different hoisting apparatus specifically sized and shaped for lifting pre-determined objects.

14. The electro-hydraulic lifting apparatus of claim 13 wherein the plurality of different hoisting apparatus including an individual hoisting apparatus for a motor, transmission, trailer, pipe, valve, human patient or animal.

15. An electro-hydraulic lifting apparatus, comprising in combination:
lifting means for precisely lifting an object with a hydraulic means, wherein the hydraulic pressure is controlled with an electrical means;
hydraulic means for precisely, automatically and dynamically controlling the lifting means by automatically adding or removing hydraulic pressure via a plurality of electro-static valves when a load is applied to lifting means and when the lifting means is moved in an up or down direction;
electrical means for controlling the hydraulic means and the plurality of electro-static valves included in the hydraulic means; and
a portable power means for providing power to the electrical means and the hydraulic means.

16. The electro-hydraulic lifting apparatus of claim 15 wherein the hydraulic means includes a two-way hydraulic ram.

17. The electro-hydraulic lifting apparatus of claim 15 wherein the portable power means includes a direct current battery.

18. The electro-hydraulic lifting apparatus of claim 15 wherein the lifting means is used to lift a motor, transmission, trailer, pipe, valve, human patient or animal.

19. The electro-hydraulic lifting apparatus of claim 15 wherein the electrical means includes a wireless electrical means.

20. An electro-hydraulic lifting apparatus, comprising in combination:
a horizontal boom for lifting an object in an up and down direction;
a two-way hydraulic ram connected to the horizontal boom for precisely raising and lowering the object in an up or down direction, wherein the two-way hydraulic ram is precisely raised and lowered with hydraulic pressure from a reservoir;
a reservoir connected to the two-way hydraulic ram to supply hydraulic fluid to provide hydraulic pressure to the two-way hydraulic ram;
a hydraulic pump connected to the hydraulic ram including a plurality of electro-static valves for automatically and dynamically controlling the two-way hydraulic ram by automatically adding or removing hydraulic pressure to the two-way hydraulic ram when a load is applied to the horizontal telescopic boom and the horizontal telescopic boom is moved in an up or down direction;
an electrical controller connected to the hydraulic pump for controlling the hydraulic pump, thereby automatically, dynamically and precisely controlling the two-way hydraulic ram; and
a portable power source for providing power to the electrical controller and the hydraulic pump.
